(19) United States
(12) Patent Application Publication
(10) Pub. No.: US 2026/0176921 A1
(43) Pub. Date: Jun. 25, 2026

(54) LADDER BODY, LADDER JOINT, AND LADDER

(71) Applicant: SUZHOU PICA ALUMINUM INDUSTRY LTD., Suzhou, Jiangsu (CN)

(72) Inventors: Xiaoyan XIE, Suzhou (CN); Yong ZHANG, Suzhou (CN)

(73) Assignee: SUZHOU PICA ALUMINUM INDUSTRY LTD., Suzhou, Jiangsu (CN)

(21) Appl. No.: 18/833,287

(22) PCT Filed: May 24, 2023
(86) PCT No.: PCT/CN2023/095947

§ 371 Date: Jul. 25, 2024

(51) Int. Cl. E06C 7/50; E06C 1/32

(52) U.S. Cl. CPC E06C 7/50; E06C 1/32

(57) ABSTRACT

A ladder joint is provided. A ladder includes two ladder bodies and the ladder joint configured to connect adjacent ladder bodies. The ladder body includes a longitudinal support body having a slot disposed at an end of the longitudinal support body for docking with the ladder joint. The ladder joint includes two insertion parts for inserting into the slot, the insertion part includes a free end and a fixed end opposite to the free end, and includes a first side opposite to a bending direction of the ladder joint, the first side of the insertion part includes first and second sections, the first section is recessed and extends from the fixed end to the free end of the first side of the insertion part, and the first and second sections are disposed in sequence in a direction of from the fixed end to the free end of the insertion part. The ladder joint can avoid the phenomenon of stress concentration of the ladder joint and/or the ladder body at this position, thereby avoiding damage or breakage of the ladder joint and/or the ladder body. The present disclosure also provides a ladder body and a ladder.

### TECHNICAL FIELD

The present disclosure relates to the field of ladder, and in particular, to a ladder body, a ladder joint, and a ladder.

### BACKGROUND

A step ladder is a ladder commonly used for height-climbing operations. Generally, a ladder includes two ladder bodies and a ladder joint for connecting the two ladder bodies. By bending the ladder joint, an angle between the two ladder bodies can be adjusted to adapt to different usage environments. For a ladder, an angle between the two ladder bodies may be adjusted between 0° and 180° by bending a ladder joint. When the angle between the two ladder bodies is 180°, the ladder is in a straight line state.

Conventionally, when the ladder is in the straight line state and carries a large load, it may be prone to bending, which causes stress concentration at a connection point between the ladder joint and the ladder body, and thus easily cause damage or breakage to the ladder joint and/or the ladder body, thereby affecting the service life of the ladder.

### SUMMARY

The description herein merely provides background information related to the present disclosure and does not necessarily constitute the prior art.

According to various embodiments of the present disclosure, a ladder body, a ladder joint, and a ladder are provided.

The ladder joint is provided, the ladder may include two ladder bodies and the ladder joint configured to connect adjacent ladder bodies. The ladder body may include a longitudinal support body. The longitudinal support body may have a slot. The slot may be disposed at an end of the longitudinal support body for docking with the ladder joint.

The ladder joint may include two insertion parts for inserting into the slot. The insertion part may include a free end and a fixed end opposite to the free end. The insertion part may include a first side opposite to a bending direction of the ladder joint, the first side of the insertion part may include a first section and a second section, the first section may be recessed, the first section may extend from the fixed end to the free end of the insertion part at the first side, and the first section and the second section may be disposed in sequence in a direction from the fixed end to the free end of the insertion part.

In the first side of the insertion part of the above-mentioned ladder joint, the first section may be recessed, so that after the ladder joint is assembled and connected to the ladder body, the first section may not directly contact to the longitudinal support body on the ladder body, and a gap may exist. Therefore, when the ladder is in a straight line state and carries a large load, even if the ladder is bent, the first section may not be abutted by the longitudinal support body, thereby avoiding the phenomenon of stress concentration of the ladder joint and/or the ladder body at this position, thus avoiding the damage or breakage of the ladder joint and/or the ladder body and improving the service life.

In one embodiment, a recessed depth of the first section may be from 0.1 mm to 2.0 mm.

In one embodiment, along an arrangement direction of the first section and the second section, a ratio of a length of the first section of the first side to a length of the first side may be 1:5 to 1:1.2.

In one embodiment, recessed degrees at different positions of the first section may be the same.

Alternatively, along a direction from the free end to the fixed end of the insertion portion, a recessed degree of the first section may gradually increase.

In one embodiment, a first buffer layer may be disposed on the first section.

According to another aspect, a ladder body is provided. A ladder may include two ladder bodies and a ladder joint configured to connect adjacent ladder bodies. The ladder body may include a longitudinal support body. The longitudinal support body may have a slot. The ladder joint may include two insertion mechanisms for inserting into the slot. The insertion mechanisms may include a first side opposite to a bending direction of the ladder joint. The ladder joint may include two insertion parts matching the slot.

The slot may have a docking section for docking with the ladder joint. The docking section may have a first inner side disposed opposite to the first side. The first inner side may include a third section. The third section may be recessed, and the third section may extend inwardly from an end of the first inner side.

In the slot of the longitudinal support body of the above-mentioned ladder body, the third section may be recessed, so that after the ladder joint is assembled and connected to the ladder body, the third section may not directly contact to the insertion part of the ladder joint, and a gap may exist. Therefore, when the ladder is in a straight state and carries a large load, even if the ladder is bent, the third section may not be abutted by the longitudinal support body, thereby avoiding the phenomenon of stress concentration of the ladder joint and/or the ladder body at this position, thus avoiding damage or destruction of the ladder joint and/or the ladder body and improving the service life.

In one embodiment, a recessed depth of the third section may be 0.1 mm-2.0 mm.

In one of the embodiments, a second buffer layer may be disposed on the third section.

According to another aspect of the present disclosure, a ladder is provided, which may include:
two ladder bodies, wherein the ladder body may include a longitudinal support body, the longitudinal support body may have a slot, and the slot may be disposed at an end of the longitudinal support body used for docking with a ladder joint;
the ladder joint configured to connect the two ladder bodies, wherein the ladder joint may include two insertion parts used for inserting into the slot, the insertion part may include a free end and a fixed end opposite to the free end, the insertion part may include a first side opposite to a bending direction of the ladder joint, the first side of the insertion part may include a first section and a second section, the first section may extend from the fixed end toward the free end of the first side of the insertion part, and the first section and the second section may be disposed in sequence in a direction from the fixed end to the free end of the insertion part,

A gap may be formed between the first section of the first side and an inner side wall of the slot.

In the above-mentioned ladder, the gap may exist between the first section of the first side and the inner side wall of the slot, so that when the ladder is in a straight state and carries a large load, even if the ladder is bent, the first section may not be abutted by the inner side wall of the slot, thereby avoiding the phenomenon of stress concentration of the ladder joint and/or the ladder body at this position, thus avoiding damage or destruction of the ladder joint and/or the ladder body and improving the service life.

In one embodiment, a size of the gap may be 0.1 mm to 2.0 mm.

In one embodiment, the first section may be recessed.

And/or, the inner side wall of the slot may include a first inner side disposed opposite to the first side. The first inner side may include a third section disposed corresponding to the first section. The third section may be recessed.

In one embodiment, the ladder may further include a buffer layer disposed in the gap.

The details of one or more embodiments of the present disclosure are set forth in the following drawings and description. Other features, purpose, and advantages of the present disclosure will become apparent from the description, drawings, and claims.

### BRIEF DESCRIPTION OF DRAWINGS

In order to better describe and illustrate the embodiments or examples of the present disclosure disclosed herein, one or more drawings may be referred to. Additional details or examples used to describe the drawings should not be considered as limiting the scope of any one of the disclosed disclosure, the embodiments or examples currently described, and the best modes of these disclosures currently understood.

FIG. 1 is a schematic structural diagram of a ladder in a line straight state (in use) according to an embodiment of the present disclosure;

FIG. 2 is a schematic diagram of a connection position between the ladder body and the ladder joint in FIG. 1;

FIG. 3 is a partial enlarged view of A in FIG. 2;

FIG. 4 is a schematic structural diagram of the ladder shown in FIG. 1 bent due to carrying a heavy object;

FIG. 5 is a schematic diagram of a connection position between the ladder body and the ladder joint in FIG. 4;

FIG. 6 is a partial enlarged view of B in FIG. 5,

FIG. 7 is a schematic diagram of a connection position between a ladder body and a ladder joint in a ladder according to another embodiment of the present disclosure;

FIG. 8 is a schematic diagram of a connection position between a ladder body and a ladder joint in a ladder according to another embodiment of the present disclosure;

FIG. 9 is a partial enlarged view of C in FIG. 8;

FIG. 10 is a schematic diagram of a connection position between a ladder body and a ladder joint in a ladder according to another embodiment of the present disclosure; and

FIG. 11 is a partial enlarged view of D in FIG. 10.

### DESCRIPTION OF REFERENCE NUMERALS

100/200/300/400, ladder;
110, ladder body; 111, longitudinal support body; 112, slot; 113, first inner side; 114, third section; 115, fourth section;
120, ladder joint; 121, insertion part; 122, free end; 123, fixed end; 124, first side; 125, first section; 126, second section,
130, gap.

### DETAILED DESCRIPTION

In order to make the purpose, technical solution, and advantages of the embodiments of the present disclosure clearer, the present disclosure is further described in detail below in combination with the accompanying drawings and the embodiments. It should be understood that the specific embodiments described here are only used to explain the present disclosure and are not intended to limit the present disclosure.

It should be noted that when an element is described as being “disposed on” another element, it may be directly on another element or an intervening element may exist. When an element is regarded as being “connected” to another element, it may be directly connected to another element or an intervening element may exist. The terms “vertical”, “horizontal”, “left”, “right”, and similar expressions used herein are for only illustrative purposes and do not represent only one implementation.

As used herein, the orientation or positional relationship indicated by the terms “center”, “longitudinal”, “lateral”, “length”, “width”, “thickness”, “height”, “upper”, “lower”, “front”, “back”, “left”, “right”, “vertical”, “horizontal”, “top”, “bottom”, “internal”, “external”, “clockwise”, and “counterclockwise”, etc. is an orientation or positional relationship shown in the drawings, which are only to facilitate simplifying the description of the present disclosure, and do not indicate that the device or element referred to must have a specific orientation, be constructed and operated in a specific orientation, that is, they cannot be understood as a limitation on the present disclosure.

The terms “first” and “second” used herein are only for the purpose of clear description and cannot be understood as the relative importance of the indicated features or the number of the indicated technical features. Therefore, features defined by “first” or “second” may expressly include at least one of the features. In the description of the present disclosure, “a plurality of” means at least two, such as two, three, etc., “several” means at least one, such as one, two, three, etc., and unless explicitly limited otherwise.

The terms “mount”, “connect with”, “connect to”, “fix”, and “dispose”, etc. used in the present disclosure should be understood in a general manner. For example, “connection” may be fixed connection, detachable connection, or integrated connection, it may also be a mechanical connection or an electrical connection, it may also be a direct connection, an indirect connection via an intermediate medium, internal communication of two elements, or interactive relationship of two elements. For those of ordinary skill in the art, the specific meanings of the above terms in the present disclosure may be understood according to specific conditions.

Unless expressly limited otherwise, a first feature is “on”, “upon”, “above”, “over”, “below”, “under”, “beneath”, or “underneath” a second feature may mean that the first feature directly contacts the second feature or the first feature indirectly contacts the second feature via an intermediate medium. Furthermore, the first feature is “on”, “above”, or “over” the second feature may mean that the first feature is directly above or diagonally above the second feature, or merely means that a horizontal height of the first feature is higher than that of the second feature. The first feature is “below”, “under”, or “underneath” the second feature may mean that the first feature is directly under or diagonally under the second feature, or merely means that the horizontal height of the first feature is less than that of the second feature.

Unless expressly defined otherwise, all technical and scientific terms used herein have the same meaning as commonly understood by those skilled in the art to which the present disclosure belong. The terms used in the description of the present disclosure are for the purpose of describing specific embodiments only and are not intended to limit the present disclosure. Various technical features of the embodiments may be combined in any way. To simplify the description, not all possible combinations of various technical features in the embodiments are described. However, as long as there is no conflict in the combination of these technical features, all possible combinations should be considered to be within the scope of the present description.

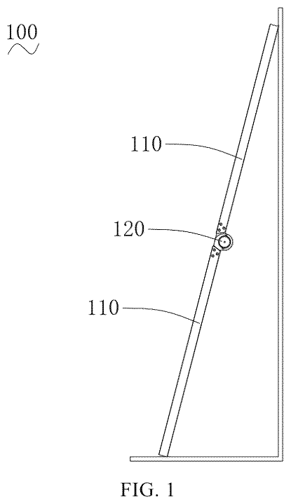

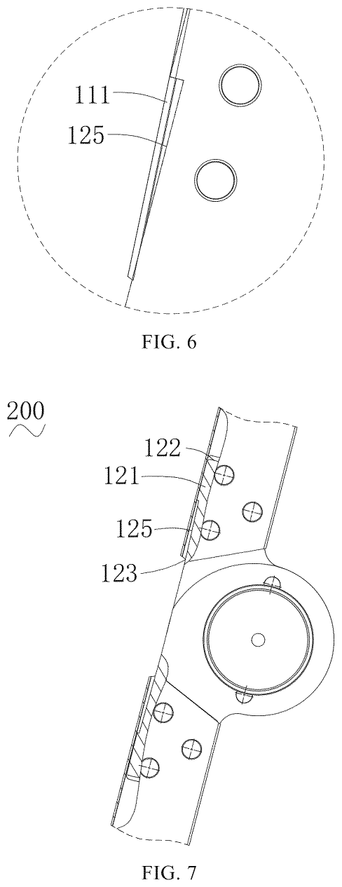

Referring to FIGS. 1 to 6, an embodiment of the present disclosure provides a ladder 100 including two ladder bodies 110 and a ladder joint 120 configured to connect the adjacent ladder bodies 110.

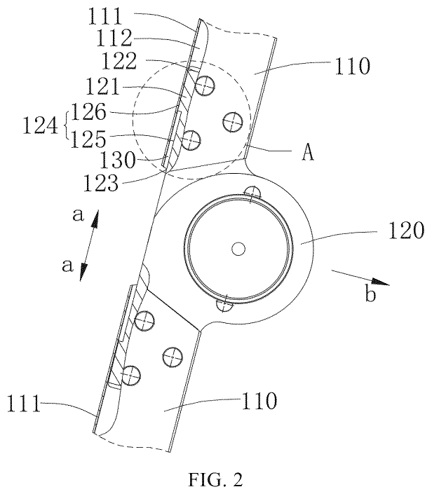

The ladder body 110 includes a longitudinal support body 111. The longitudinal support body 111 has a slot 112. The slot 112 is disposed at an end of the longitudinal support body 111 for docking with the ladder joint 120. It can be understood that a depth direction of the slot 112 may be a direction in which the longitudinal support body 111 extends, that is, the longitudinal direction, i.e., the a-a direction in FIG. 2.

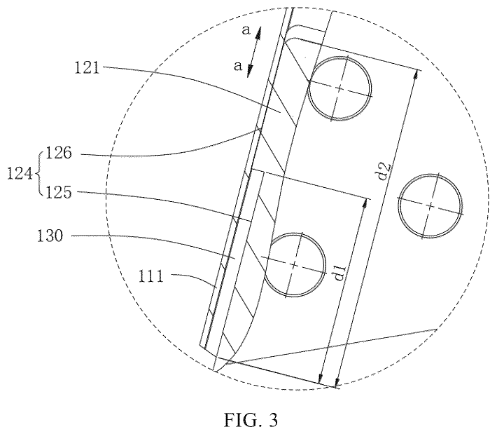

Specifically, referring to FIG. 2 and FIG. 3, the ladder joint 120 includes two insertion parts 121 for inserting into the slot 112. The insertion part 121 has a free end 122 and a fixed end 123 opposite to the free end 122. The insertion part 121 has a first side 124 opposite to a bending direction of the ladder joint 120. It can be understood that the bending direction of the ladder joint 120 may be the b direction in FIG. 2. Specifically, the first side 124 of the insertion part 121 includes a first section 125 and a second section 126. The first section 125 is recessed. The first section 125 extends from the fixed end 123 to the free end 122 of the insertion part 121 at the first side 124. The first section 125 and the second section 126 are arranged in sequence in a direction from the fixed end 123 to the free end 122 of the insertion part 121.

The first section 125 is recessed in the first side 124 of the insertion part 121 of the ladder joint 120, so that after the ladder joint 120 is assembled and connected to the ladder body 110, the first section 125 may be not in direct contact with the longitudinal support body 111 on the ladder body 110, and a gap 130 may exist. Therefore, even if the ladder 100 is bent, the first section 125 will not be abutted by the longitudinal support body 111, thereby avoiding the phenomenon of stress concentration of the ladder joint 120 and/or the ladder body 110 at this position, thereby avoiding damage or breakage of the ladder joint 120 and/or the ladder body 110, and improving the service life thereof.

In addition, for the above-mentioned ladder joint 120, only the first section 125 of the first side 124 may be recessed. When the ladder 100 is in the straight line state, the second section 126 may abut against a side wall of the slot 112, thereby improving the stability of the connection between the ladder joint 120 and the ladder body 110 and better ensuring the safety of the ladder 100.

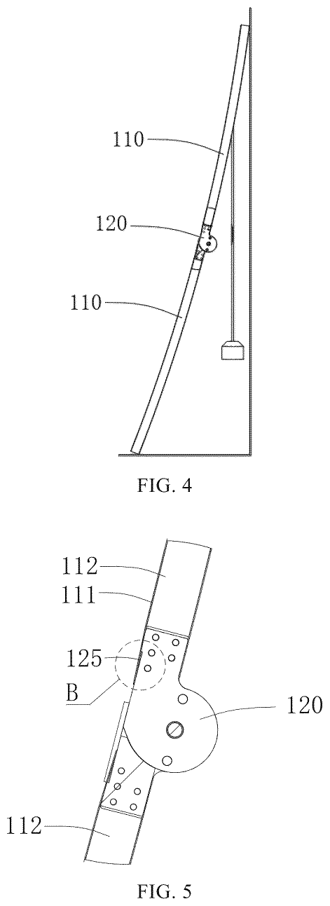

Furthermore, when the ladder 100 is in a straight line state and carries a large load, in a case that the ladder 100 is bent to a certain extent, the first section 125 may also abut against the side wall of the slot 112, please refer to FIGS. 4 to 6. Thus, on one hand, the stability of the connection between the ladder joint 120 and the ladder body 110 can be better ensured, thereby better ensuring the safety of the ladder. On the other hand, after the first section 125 abuts against the side wall of the slot 112, the ladder joint 120 and the ladder body 110 may further share the bending stress generated by the bending of the ladder 100, thereby avoiding the phenomenon that one of the ladder joint 120 and the ladder body 110 may be easily damaged due to the large force, thereby improving the service life of the ladder joint 120 and the ladder body 110. On the other hand, while achieving the above-mentioned beneficial effects, both of the cost and the structural complexity of the ladder 100 are not increased too much.

Specifically, in the embodiments as shown in FIGS. 1 to 6, each ladder body 110 may include two longitudinal support bodies 111, and the two ladder bodies 110 may be connected by two ladder joints 120. It can be understood that, in other embodiments, each ladder body may have only one longitudinal support body or more than two longitudinal support bodies. Similarly, the two ladder bodies may be connected by one ladder joint or more than two ladder joints.

For the ladder 100 shown in FIGS. 1 to 6, each ladder body 110 may include two longitudinal support bodies 111, and the two ladder bodies 110 may be connected by two ladder joints 120. In some countries'safety test requirements, it is necessary to perform a test in a case that only one ladder joint 120 is in action, and the load required to be borne during the test is 3.2 to 4 times the load requirement of the ladder 100. The configuration of the recessed first section 125 in the ladder joint 120 improves the connection stability of the ladder 100 without increasing the cost too much, and better meets or even exceeds the safety test standard.

In addition, currently, the commonly used way for improving the load-bearing capacity of the ladder 100 is to increase the cross-sectional area of the longitudinal support 111 or change the material of the longitudinal support 111, to increase the load-bearing capacity of the ladder 100. However, by adopting the configuration of the above-mentioned structure, the load-bearing capacity of the ladder 100 can be improved without increasing the cross-sectional area of the longitudinal support 111 or changing its material. Thus, the load-bearing capacity of the ladder 100 can be improved without increasing the cost too much.

It should be understood that the ladder body 110 may further include a trampling mechanism (not shown) which is fixedly disposed on the longitudinal support body 111 along a transverse direction for a user to trample when climbing up through the ladder 100. The specific structure of the trampling mechanism may adopt a conventional configuration in the art.

Optionally, in a feasible embodiment, a recessed depth of the first section 125 may be 0.1 mm to 2.0 mm, thus avoiding excessively affecting the strength of the ladder joint 120 while the ladder joint 120 can achieve the above-mentioned beneficial effects. Specifically, the recessed depth of the first section 125 may be 0.1 mm, 0.3 mm, 0.5 mm, 0.7 mm, 0.9 mm, 1 mm, 1.2 mm, 1.4 mm, 1.6 mm, 1.8 mm, 2 mm, etc.

Optionally, along an arrangement direction of the first section 125 and the second section 126, i.e., an a-a direction, a ratio of a length d1 of the first section 125 of the first side 124 to a length d2 of the first side 124 may be 1:5 to 1:1.2, thus ensuring the abutment stability of the ladder joint 120 and the ladder body 110 while the ladder joint 120 can achieve the above-mentioned beneficial effects.

Specifically, in the embodiment shown in FIG. 2 and FIG. 3, the first side 124 may only include the first section 125 and the second section 126. It can be understood that, in other embodiments, the first side is not limited to only including the first and second sections. For example, in a feasible embodiment, the first side may also include a transition section disposed between the first section and the second section. A recessed depth of the transition section may gradually decrease in a direction from the first section to the second section. In the transition section, a recessed depth of an end connected to the first section may be equal to the recessed depth of the first section, and a recessed depth of an end connected to the second section may be 0.

Optionally, referring to FIG. 3, recessed degrees at different positions of the first section 125 may be the same.

Optionally, referring to a ladder 200 shown in FIG. 7, along a direction from a free end 122 to a fixed end 123 of the insertion portion 121, the recessed degree of the first section 125 may gradually increase.

Optionally, in another feasible embodiment, a first buffer layer may be disposed on the first section. Thus, even when the first section of the first side of the ladder joint indirectly abuts against the longitudinal support body of the ladder body during a bending process of the ladder, the first buffer layer can relieve the stress of the ladder joint and the ladder body at this position, thereby reducing the abutting pressure on the first section of the first side of the ladder joint, and also reducing the abutting pressure on the longitudinal support body at this position, thereby reducing the risk of damage to the ladder joint and the longitudinal support body at this position and increasing the service life of the ladder joint, the ladder body, and the ladder.

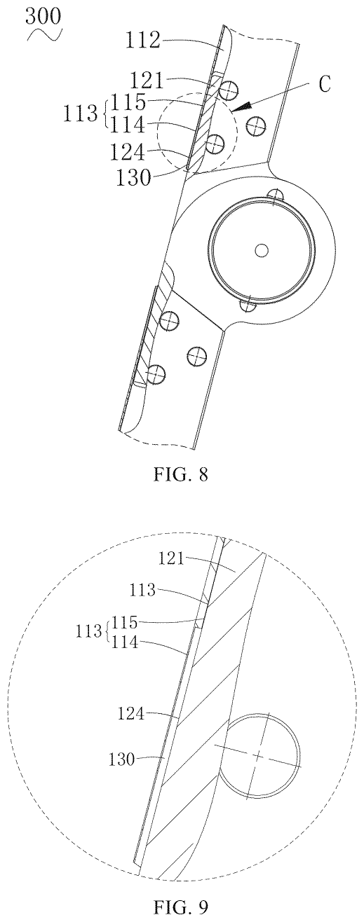

Referring to FIGS. 8 and 9, a ladder 300 provided in another embodiment of the present disclosure may be different from the ladder 100 in that: a slot 112 may have a docking section for docking with the ladder joint 120, and the docking section may have a first inner side 113 disposed opposite to the first side 124. The first inner side 113 may include a third section 114. The third section 114 may be recessed. The third section 114 may extend inwardly from an end of the first inner side 113. That is, a gap 130 of the ladder 300 may be formed through the configuration of the recessed third section 114.

Of course, the first inner side 113 may further include a fourth section 115 disposed opposite to the first side 124. The fourth section 115 may be approximately mated with the first side 124. In other words, a slight gap may be formed between the fourth section 115 and the first side 124, so that the insertion portion 121 may be easily inserted into the slot 112.

Optionally, a recessed depth of the third section 114 may be 0.1 mm to 2.0 mm. Specifically, the recessed depth of the third section 114 may be 0.1 mm, 0.3 mm, 0.5 mm, 0.7 mm, 0.9 mm, 1 mm, 1.2 mm, 1.4 mm, 1.6 mm, 1.8 mm, 2 mm, etc.

Optionally, in another feasible embodiment, a second buffer layer may be disposed on the third section. It can be understood that the function of the second buffer layer may be the same as that of the first buffer layer, and only positions thereof are different.

It can be understood that the positions of the above-mentioned first buffer layer and second buffer layer may be selected to facilitate the positioning and assembling of the first buffer layer and the second buffer layer through the recessed position.

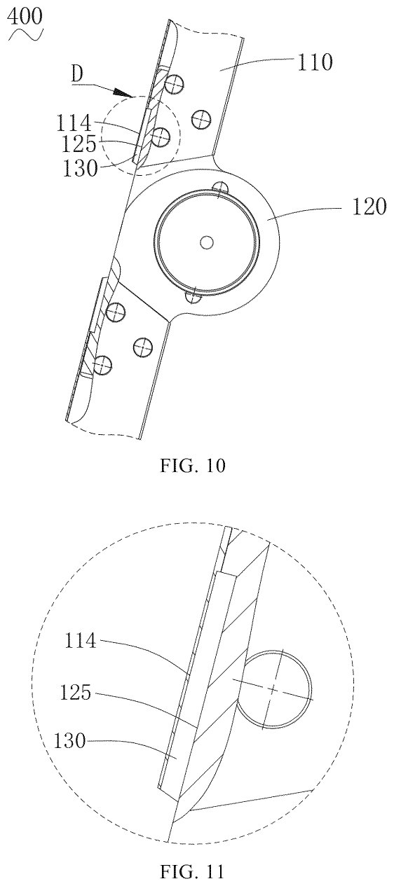

Referring to FIGS. 10 and 11, a ladder 400 provided in another embodiment of the present disclosure may be different from the ladder 100 and the ladder 300 in that: the third section 114 and the first section 125 may be both recessed, that is, the ladder 400 may form a gap 130 by recessing the first section 125 and the third section 114.

The gap 130 formed in this way can reduce the recessed depths of the first section 125 and the third section 114, thereby achieving the same beneficial effects as described above, further avoiding excessively affecting the structural strength of the ladder joint 120 due to the recess configuration of the first section 125, and also avoiding excessively affecting the structural strength of the ladder body 110 due to the recess configuration of the third section 114.

Optionally, the size of the gap 130 may be 0.1 mm to 2.0 mm. Specifically, the size of the gap 130 may be 0.1 mm, 0,3 mm, 0.5 mm, 0.7 mm, 0.9 mm, 1 mm, 1.2 mm, 1.4 mm, 1.6 mm, 1.8 mm, 2 mm, etc.

Optionally, the ladder may further include a buffer layer disposed in the gap. It can be understood that the buffer layer herein may be the aforementioned first buffer layer, the aforementioned second buffer layer, or a combination of the first buffer layer and the second buffer layer.

Various technical features in the above-described embodiments may be arbitrarily combined. To make the description concise, not all possible combinations of the various technical features in the above-described embodiments are described. However, as long as there is no conflict in the combination of these technical features, all should be considered to be within the scope of this specification.

The above-mentioned embodiments only express several implementations of the present disclosure, and the descriptions thereof are relatively specific and detailed, but it cannot be understood as limiting the scope of the present disclosure. It should be noted that, for those skilled in the art, various variations and improvements can be made without departing from the concept of the present disclosure, and these all belong to the protection scope of the present disclosure. Therefore, the protection scope of the present disclosure shall be subject to the attached claims.

1. A ladder joint, wherein a ladder comprises two ladder bodies and the ladder joint configured to connect adjacent ladder bodies, the ladder body comprises a longitudinal support body having a slot, and the slot is disposed at an end of the longitudinal support body for docking with the ladder joint, and
the ladder joint comprises two insertion parts for inserting into the slot, the insertion part comprises a free end and a fixed end opposite to the free end, the insertion part comprises a first side opposite to a bending direction of the ladder joint, the first side of the insertion part comprises a first section and a second section, the first section is recessed and extends from the fixed end to the free end of the insertion part at the first side, and the first section and the second section are disposed in sequence in a direction from the fixed end to the free end of the insertion part.

2. The ladder joint according to claim 1, wherein a recessed depth of the first section is from 0.1 mm to 2.0 mm.

3. The ladder joint according to claim 1, wherein along an arrangement direction of the first section and the second section, a ratio of a length of the first section of the first side to a length of the first side is 1:5 to 1:1.2.

4. The ladder joint according to claim 1, wherein a first buffer layer is disposed on the first section.

5. A ladder body, wherein a ladder comprises two ladder bodies and a ladder joint configured to connect adjacent ladder bodies, the ladder body comprises a longitudinal support body having a slot, the ladder joint comprises two insertion mechanisms for inserting into the slot, the insertion mechanism comprises a first side opposite to a bending direction of the ladder joint, and the ladder joint comprises two insertion parts matching the slot; and
wherein the slot has a docking section for docking with the ladder joint, the docking section has a first inner side disposed opposite to the first side, the first inner side comprises a third section, and the third section is recessed and extends inwardly from an end of the first inner side.

6. The ladder body according to claim 5, wherein a recessed depth of the third section is 0.1 mm to 2.0 mm.

7. The ladder body according to claim 5, wherein a second buffer layer is disposed on the third section.

8. A ladder comprising:
two ladder bodies, wherein the ladder body comprises a longitudinal support body having a slot, and the slot is disposed at an end of the longitudinal support body for docking with a ladder joint; and
the ladder joint configured to connect the two ladder bodies, wherein the ladder joint comprises two insertion parts for inserting into the slot, the insertion part comprises a free end and a fixed end opposite to the free end, the insertion part comprises a first side opposite to a bending direction of the ladder joint, the first side of the insertion part comprises a first section and a second section, the first section extends from the fixed end toward the free end of the insertion part at the first side, and the first section and the second section are disposed in sequence in a direction from the fixed end to the free end of the insertion part,
wherein a gap is formed between the first section of the first side and an inner side wall of the slot.

9. The ladder according to claim 8, wherein
a size of the gap is 0.1 mm to 2.0 mm, and
the first section is recessed.

10. The ladder according to claim 8, further comprising a buffer layer disposed in the gap.

11. The ladder joint according to claim 2, wherein a first buffer layer is disposed on the first section.

12. The ladder joint according to claim 3, wherein a first buffer layer is disposed on the first section.

13. The ladder body according to claim 6, wherein a second buffer layer is disposed on the third section.

14. The ladder according to claim 8, wherein
the inner side wall of the slot comprises a first inner side disposed opposite to the first side, and
the first inner side comprises a third section disposed corresponding to the first section, and the third section is recessed.

15. The ladder according to claim 14, further comprising a buffer layer disposed in the gap.

16. The ladder according to claim 9, wherein
the inner side wall of the slot comprises a first inner side disposed opposite to the first side,
the first inner side comprises a third section disposed corresponding to the first section, and
the third section is recessed.

17. The ladder according to claim 16, further comprising a buffer layer disposed in the gap.

18. The ladder according to claim 9, further comprising a buffer layer disposed in the gap.
